(19) United States
(12) Patent Application Publication
(10) Pub. No.: US 2007/0033426 A1
(43) Pub. Date: Feb. 8, 2007

(54) System and method for direct-attached storage and network-attached storage functionality for laptops and PCs

(76) Inventors: Bruce Wilson, San Jose, CA (US); Jorge Campello, Cupertino, CA (US); Richard Michael Hamilton New, San Jose, CA (US)

Correspondence Address: ROGITZ & ASSOCIATES, 750 B STREET, SUITE 3120, SAN DIEGO, CA, 92101, US

(21) Appl. No.: 11/200,284

(22) Filed: Aug. 8, 2005

(51) Int. Cl. G06F 1/30

(52) U.S. Cl. 713/324

(57) ABSTRACT

A chipset in a host computer enables the internal HDD of the host computer to be accessed by another computer either through the USB port (for direct access shared storage) or the Ethernet port (for network attached storage) without having to boot the host computer.

### FIELD OF THE INVENTION

The present invention relates generally to systems and methods for establishing direct-attached storage and network-attached storage functionality to laptops and personal computers (PCs).

### BACKGROUND OF THE INVENTION

Computers may share storage capabilities across a network. For example, the hard disk drive (HDD) of a computer may be accessed and shared by other computers over a network. In some shared storage systems, such as direct-access systems, communication with a HDD from an external computer may be through a universal serial bus (USB) port, while in, e.g., network attached storage (NAS) systems that function over local area networks (LAN), communication may be through an Ethernet port.

As recognized herein, regardless of the particular mode of shared storage, to access data stored on a HDD in, e.g., a laptop or desktop PC (“host computer”), the user must first boot up the host computer. To facilitate this, features such as wake-on-LAN are sometimes used. The problem with wake-on-LAN or other methods is that a long latency must be accepted while the host computer boots. Moreover, while the host computer runs, it generates heat and noise and consumes power. With these critical recognitions in mind, the invention herein is provided.

### SUMMARY OF THE INVENTION

A host computer chipset is provided to allow the hard disk drive (HDD) of the host computer to be accessed as a Direct-Attached or Network-Attached storage device without powering up the entire computer.

Accordingly, a chipset for connecting an internal hard disk drive (HDD) of a host computer to at least one external data communication port for accessing of the HDD by an accessing computer embodies logic that includes energizing the HDD without booting the host computer, and permitting the accessing computer to access the HDD through the port while the host computer is not booted.

In non-limiting implementations the chipset can be implemented, without limitation, on a motherboard of the host computer, or on the HDD, or by a plug-in card of the host computer, or by an add-in card of the host computer.

In other non-limiting embodiments, the host computer can be a laptop computer and the port can be a type B USB port, with the HDD being accessed as a direct-access storage device. Or, the port can be a network connection port such as, e.g., an Ethernet port, and the HDD can be accessed as a network-attached storage (NAS) device.

In another aspect, a host computer includes an HDD that is internal to the host computer and at least one data port configured to allow access to the HDD by an accessing computer remote from the host computer. Means are provided for allowing the accessing computer to communicate with the HDD without booting the host computer. The means for allowing may permit energizing the HDD using an internal power supply of the host computer, or energizing the HDD over the data port.

In still another aspect, a method includes energizing a HDD that is internal to a host computer without booting the host computer, and accessing, through a port of the host computer, data on the HDD using an accessing computer remote from the host computer.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system according to the present invention; and

FIG. 2 is a flow chart of the shared storage logic of the present invention.

### DETAILED DESCRIPTION OF THE PREFERRED EMBODIMENT

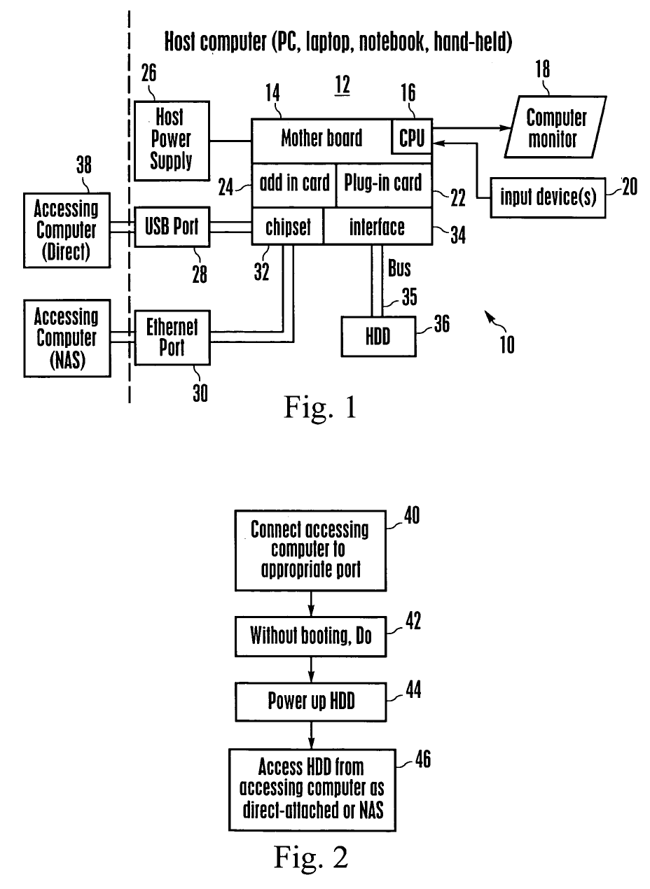

Referring initially to FIG. 1, a shared storage system is shown, generally designated 10, which includes at least one host computer 12 that may be, e.g., a laptop computer, a personal computer (PC), a notebook computer, a hand-held (palm) computer, etc. The host computer 12 includes a motherboard 14 that bears at least one central processing unit (CPU) 16, with the CPU 16 providing output for display on a computer monitor 18 and receiving input from the input devices 20 (e.g., keyboards, mice, voice recognition devices, etc.) of the host computer 12. One or more plug-in cards 22 such as video cards may be engaged with the motherboard 14. Also, add-on cards 24 may be engaged in accordance with principles known in the art with the motherboard 14 and/or with the internal data bus of the host computer 12. The add-in card may be any appropriate device such as but not limited to an ExpressCard, CardBus, or an appropriately configured personal computer memory card international association (PCMCIA) card. The internal components of the host computer 12 may be powered by a host power supply 26, such as, e.g., a rechargeable dc battery and/or an ac rectified power supply that receives input power from the ac grid.

To support external communication, the host computer 12 may have a type “A” universal serial bus (USB) port 28. Alternatively the USB port may be a type “B” USB port, which heretofore has been used on peripheral devices. Further, the host computer 12 may have an Ethernet port 30. Both ports 28, 30 may be connected to a chipset 32 that may implement the logic of FIG. 2. By “chipset” is meant one or more computer logic chips on a substrate.

As shown in FIG. 1, in a non-limiting embodiment the chipset 32 exposes a disk drive interface 34 that in turn communicates with or is part of a disk drive bus 35. The precise nature of the bus 35 and associated internal busses of the computer over which data from the disk drive bus 35 and CPU 16 is exchanged is not limiting or central to the invention. By way of non-limiting illustration, the bus 35 may be an advanced technology attachment (ATA) bus (or similar such as PATA, IDE or EIDE, etc.), or a small computer system interface (SCSI) bus or derivatives thereof, or other type of bus.

In accordance with principles known in the art, the host computer 12 includes one or more internal hard disk drives (HDD) 36. With the above components in mind, it is to be understood that while the chipset 32 is shown being implemented as part of the motherboard 14, it may alternatively be implemented by the plug-in card 22, or by an add-in card 24 (into which the HDD would be plugged so that the add-in card would be interposed between the HDD and motherboard), or by the HDD 36, e.g., by the controller circuitry of the HDD 36.

In any case, as set forth further below, an accessing computer 38 that is remote from (i.e., separate from) the host computer 12 can access the HDD 36 as a direct-access device by means of the chipset 32 through the USB port 28, without booting the CPU 16 of the host computer 12. In addition to or in lieu of direct-access, an accessing computer 38 may access the HDD 36 as a network-attached storage (NAS) device through the Ethernet port 30, again without booting the CPU 16 of the host computer 12. A low-power microprocessor may be included in the chipset 32 to implement a network interface, with the file system (such as, e.g., a file allocation table) of the host computer 12 being exported to the chipset 32 by means of an appropriate protocol. In any case, the accessing of the HDD by the accessing computer 38 by default can have no security provisions, it being understood that security provisions can be added using, e.g., the same mechanism used to secure USB flash storage devices. In non-limiting examples of security, for network-attached storage security ordinarily is required and is integral to common protocols, whereas for direct-attached storage, a basic device password such as is currently used for USB flash drives may suffice.

Now referring to FIG. 2, the present logic embodied in the chipset 32 can be seen. Commencing at block 40, the accessing computer 38 is connected to the appropriate port, e.g., the USB port 28 for direct access or the Ethernet port 30 for NAS access. When the USB port 28 is used, and the USB port is a type “B” port, in a non-limiting preferred embodiment a standard USB cable having a “type A” connector on one end and a “type B” connector on the other end may be used, with the type “A” connector being connected to the accessing computer 38 and the type “B” connector being connected to the USB port 28. Or, in another non-limiting embodiment if the USB port 28 is a type “A” port, a USB connector cable having opposed type “A” connectors may be used.

Proceeding to block 42, a DO loop is entered without booting the host computer 12. At block 44, the HDD 36 is powered up. Power may be supplied by the host computer power supply 26, or it may be supplied from the accessing computer 38 through the relevant port 28, 30, it being understood that the chipset 32 is always powered up while it is desirable to establish shared storage. At block 46, the accessing computer 38 communicates with the HDD 36 as a direct-access device or NAS device, with the host computer 12 remaining unbooted. The communication includes data access, i.e., reading and/or writing data to the HDD 36.

It may now be appreciated that because the host computer 12 remains unbooted, the computer monitor 18 and input devices 20 need not be used during the operation at block 46. Accordingly, the chipset 32 may provide separate power control between normal use (i.e., host computer 12 booted) and the above-described unbooted use. If desired, separate security rules can be maintained between normal use and unbooted use. In non-limiting implementations, a flash memory device may be provided in the HDD 36 for storing configuration & security settings, such that the firmware is updatable. Further, if desired the HDD 36 may be partitioned into separate regions, one for use by the host computer 12 and one for use by the accessing computer 38. To this end, a “partition” separation or “file sharing” separation may be used between the two partitions.

While the particular SYSTEM AND METHOD FOR DIRECT-ATTACHED STORAGE AND NETWORK-ATTACHED STORAGE FUNCTIONALITY FOR LAPTOPS AND PCs as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A chipset for connecting an internal hard disk drive (HDD) of a host computer to at least one external data communication port for accessing of the HDD by an accessing computer, the chipset embodying logic comprising:
energizing the HDD without booting the host computer; and
permitting the accessing computer to access the HDD through the port while the host computer is not booted.

2. The chipset of claim 1, wherein the chipset is implemented by an add-in card pluggable into a motherboard of the host computer.

3. The chipset of claim 1, wherein the chipset is implemented on a motherboard of the host computer.

4. The chipset of claim 1, wherein the chipset is implemented on the HDD.

5. The chipset of claim 1, wherein the chipset is implemented by a plug-in card of the host computer.

6. The chipset of claim 1, comprising a host computer supporting the chipset.

7. The chipset of claim 6, wherein the host computer is a laptop computer and the port is a type B USB port, the HDD being accessed as a direct-access storage device.

8. The chipset of claim 6, wherein the port is a network connection port, the HDD being accessed as a network-attached storage (NAS) device.

9. A host computer, comprising:
at least one HDD internal to the host computer;
at least one data port configured to allow access to the HDD by an accessing computer remote from the host computer;
at least one central processing unit for booting the host computer; and
means for allowing the accessing computer to communicate with the HDD without booting the host computer.

10. The computer of claim 9, wherein the means for allowing access permits energizing the HDD using an internal power supply of the host computer.

11. The computer of claim 9, wherein the means for allowing access permits energizing the HDD over the data port.

12. The computer of claim 9, wherein the means for allowing permits accessing the HDD as a direct-access device through a USB port of the host computer.

13. The computer of claim 9, wherein the means for allowing permits accessing the HDD as a NAS device through a network connection port of the host computer.

14. The computer of claim 9, wherein the means for allowing is embodied by the HDD.

15. The computer of claim 9, wherein the means for allowing is embodied by a motherboard of the host computer.

16. The computer of claim 9, wherein the means for allowing is embodied by a card engageable with a motherboard of the host computer.

17. A method, comprising:
energizing a HDD internal to a host computer without booting the host computer; and
accessing, through a port of the host computer, data on the HDD using an accessing computer remote from the host computer.

18. The method of claim 17, wherein the HDD is accessed through a USB port.

19. The method of claim 18, wherein the USB port is a type A USB port.

20. The method of claim 18, wherein the USB port is a type B USB port.

21. The method of claim 17, wherein the HDD is accessed through a network connection port.
